(19) United States
(12) Patent Application Publication
(10) Pub. No.: US 2026/0221788 A1
(43) Pub. Date: Jul. 30, 2026

(54) ELECTRONIC DEVICE AND BATTERY BALANCE CONTROL METHOD

(71) Applicant: Smarter Silicon (Shanghai) Technologies Co., Ltd., Shanghai (CN)

(72) Inventors: Jialiang ZHANG, Shanghai (CN); Yuanpeng XIE, Shanghai (CN); Zheng LIU, Shanghai (CN)

(21) Appl. No.: 19/578,302

(22) Filed: Mar. 25, 2026

Related U.S. Application Data
(63) Continuation of application No. PCT/CN2024/098375, filed on Jun. 11, 2024.

(30) Foreign Application Priority Data
Sep. 28, 2023 (CN) 202311283248.9

(51) Int. Cl. H02J 7/52; H01M 10/42; H02J 7/00; H02J 7/50; H02J 7/80; H02J 7/96; H01M 10/44

(52) U.S. Cl. CPC H02J 7/52; H01M 10/425; H02J 7/575; H02J 7/80; H02J 7/855; H02J 7/96; H01M 2010/4271; H01M 10/44; H02J 2207/20

(57) ABSTRACT

An electronic device and its battery balance control method are provided. The electronic device includes a battery assembly and a controller. The battery assembly includes at least two batteries and a switching component. The switching component is configured to switch a connection mode between the at least two batteries. The controller is connected to the switching component and configured to control the switching component to connect the at least two batteries in a corresponding target connection mode based at least on operating states of the at least two batteries. The operating states include at least one of a charging state or a discharging state, and the target connection mode includes at least one of a parallel connection or a series connection.

### CROSS-REFERENCE TO RELATED APPLICATION

This application is a continuation application of International Patent Application No. PCT/CN2024/098375, filed on June 11, 2024, which claims priority of Chinese Patent Application No. 202311283248.9, filed on September 28, 2023, the entire contents of all of which are incorporated herein by reference.

### TECHNICAL FIELD

The present disclosure generally relates to the field of battery technologies and, more particularly, to an electronic device and a battery balance control method.

### BACKGROUND

With the increasing power consumption of electronic devices, the demand for charging power is also growing. The power supply scheme with two series of batteries is becoming more and more frequent in the design of consumer electronics systems such as mobile phones and tablets. If the battery voltages are inconsistent, it will severely affect the products’ battery life and stability. Balance control of the two series of batteries is crucial for the system’s safe battery life.

However, the circuit connection of the two series of batteries is fixed during charging or discharging, and cannot be adjusted according to the charging or discharging states of batteries, thus failing to achieve effective balance control.

### SUMMARY

In accordance with the present disclosure, there is provided an electronic device. The electronic device includes a battery assembly and a controller. The battery assembly includes at least two batteries and a switching component. The switching component is configured to switch a connection mode between the at least two batteries. The controller is connected to the switching component and configured to control the switching component to connect the at least two batteries in a corresponding target connection mode based at least on operating states of the at least two batteries. The operating states include at least one of a charging state or a discharging state, and the target connection mode includes at least one of a parallel connection or a series connection.

Also in accordance with the present disclosure, there is provided a battery balance control method of an electronic device with at least two batteries. The method includes: determining operating states of the at least two batteries, where the operating states include a charging state or a discharging state; and controlling the at least two batteries to be connected in a corresponding target connection mode at least based on the operating states of the at least two batteries, where the target connection mode includes a parallel connection or a series connection.

Also in accordance with the present disclosure, there is provided a non-transitory computer-readable storage medium containing a computer program that, when being executed, causes one or more processors to implement a battery balance control method of an electronic device with at least two batteries by performing: determining operating states of the at least two batteries, where the operating states include a charging state or a discharging state; and controlling the at least two batteries to be connected in a corresponding target connection mode at least based on the operating states of the at least two batteries, where the target connection mode includes a parallel connection or a series connection.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a schematic structural diagram of an exemplary electronic device consistent with various embodiments of the present disclosure.

FIG. 2 is a schematic structural diagram of another exemplary electronic device consistent with various embodiments of the present disclosure.

FIG. 3 is a schematic structural diagram of a battery assembly in another exemplary electronic device consistent with various embodiments of the present disclosure.

FIG. 4 is a schematic structural diagram of a controller in another exemplary electronic device consistent with various embodiments of the present disclosure.

FIG. 5 is a schematic structural diagram of a controller in another exemplary electronic device consistent with various embodiments of the present disclosure.

FIG. 6 is a schematic structural diagram of a battery assembly in another exemplary electronic device consistent with various embodiments of the present disclosure.

FIG. 7 is a schematic structural diagram of another exemplary electronic device consistent with various embodiments of the present disclosure.

FIG. 8 is a schematic diagram of a scenario of an exemplary electronic device consistent with various embodiments of the present disclosure.

FIG. 9 is a flow chart of an exemplary battery balance control method consistent with various embodiments of the present disclosure.

FIG. 10 is a flow chart of another exemplary battery balance control method consistent with various embodiments of the present disclosure.

FIG. 11 is a flow chart of another exemplary battery balance control method consistent with various embodiments of the present disclosure.

FIG. 12 is a flow chart of another exemplary battery balance control method consistent with various embodiments of the present disclosure.

FIG. 13 is a flow chart of another exemplary battery balance control method consistent with various embodiments of the present disclosure.

FIG. 14 is a schematic diagram showing topological simulation of circuits in an exemplary electronic device consistent with various embodiments of the present disclosure.

FIG. 15 is a schematic diagram showing a current curve of C4 in topological simulation results of circuits in an exemplary electronic device consistent with various embodiments of the present disclosure.

FIG. 16 is a schematic diagram showing voltage curves of two batteries in topological simulation results of circuits in an exemplary electronic device consistent with various embodiments of the present disclosure.

FIG. 17 is a schematic diagram showing a voltage difference curve of two batteries in topological simulation results of circuits in an exemplary electronic device consistent with various embodiments of the present disclosure.

FIG. 18 is a schematic diagram showing a system voltage curve in topological simulation results of circuits in an exemplary electronic device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

Unless otherwise defined, all technical and scientific terms used in the present disclosure have the same meaning as those generally understood by those skilled in the art to which the present disclosure belongs. The terms used herein are only for the purpose of describing the present disclosure and are not intended to limit the scope of the present disclosure.

In the following description, “some embodiments”, “this embodiment”, one embodiment”, and “examples”, etc., describe subsets of all possible embodiments. But it is understood that “some embodiments” can be the same subset or different subsets of all possible embodiments, and can be combined with each other without conflict.

In the following description, the terms “first/second/third” or similar terms involved are only used to distinguish similar objects, and do not represent a specific order for the objects. It is understandable that items described by “first/second/third” may be interchanged with a specific order or sequence where permitted, such that the present disclosure described here can be implemented in an order other than that illustrated or described here.

In the present disclosure, the term “and/or” is only a kind of association relationship describing associated objects, indicating that there can be three types of relationships. For example, “object A and/or object B” may represent: object A exists alone, object A and object B exist at the same time, or object B exists alone.

Unless otherwise defined, all technical and scientific terms used herein have the same meaning as commonly understood by one of ordinary skill in the art to which the present disclosure belongs. The terminology used herein is for descriptive purposes only and is not intended to limit the scope of the present disclosure.

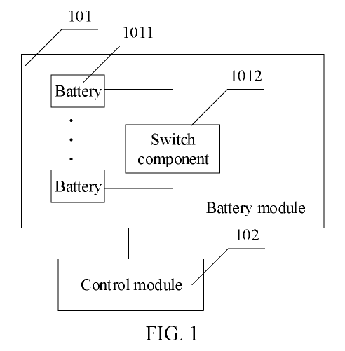

The present disclosure provides an electronic device. In one embodiment, as shown in FIG. 1 which is a schematic diagram of an electronic device according to the present disclosure, the electronic device may include a battery assembly 101 and a controller 102.

The battery assembly 101 may include at least two batteries 1011 and a switching component 1012. The switching component 1012 may be used to switch a connection mode between the at least two batteries.

The controller 102 may be connected to the switching component and may be used to control the switching component to connect the at least two batteries in a corresponding target connection mode, at least based on operating states of the at least two batteries. The operating states may include at least one of charging or discharging states, and the target connection mode may include at least one of parallel or series connections.

The at least two batteries in the battery assembly may be switched to different connection modes via the switching component.

The switching component may perform the switching based on the control of the controller.

The controller may determine the operating states of the at least two batteries and control the connection mode of the at least two batteries in the battery assembly based on these operating states.

For example, the at least two batteries may be in a charging or discharging state. Correspondingly, the controller, based on the charging/discharging efficiency of the at least two batteries and considering their different operating states, may determine the target connection mode for the at least two batteries and control the at least two batteries to switch to the target connection mode via the switching component.

The target connection mode may be a series connection or a parallel connection.

It should be noted that the process of determining the target connection mode will be described in detail in subsequent embodiments, as well as the specific connection form of the target connection mode; this embodiment will not elaborate on this.

The present disclosure provides an electronic device including a battery assembly and a controller. The battery assembly may include at least two batteries and a switching component, with the switching component being used to switch the connection mode between the at least two batteries. The controller connected to the switching component may be used to control the switching component to connect the at least two batteries in a corresponding target connection mode based at least on the operating states of the at least two batteries. The operating states may include at least one of a charging state or a discharging state, and the target connection mode may include at least one of a parallel connection or a series connection. In this embodiment, the electronic device may include a battery assembly and a controller. The battery assembly may include at least two batteries and a switching component. The switching component may be used to switch the connection mode between the at least two batteries. The controller may be used to control the switching component to connect the at least two batteries in a target connection mode based on whether the at least two batteries are in a charging state or a discharging state. The target connection mode may include at least one of a parallel connection or a series connection. Therefore, the switching of different connection modes according to the operating states of the at least two batteries may be achieved, and the connection mode of the at least two batteries may be more in line with the needs of the current operating states, thereby improving the power supply/charging efficiency.

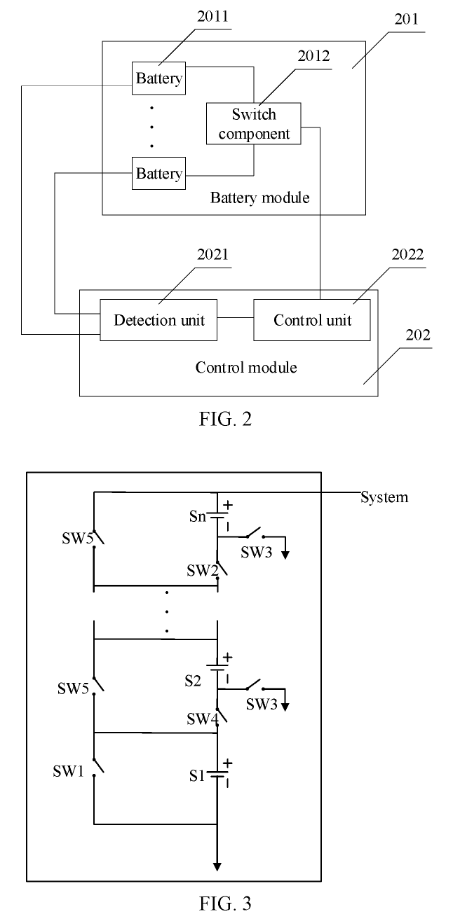

In another embodiment, as shown in FIG. 2 which is a schematic diagram of another electronic device according to the present disclosure, the electronic device may include a battery assembly 201 and a controller 202.

The battery assembly 201 may include at least two batteries 2011 and a switching component 2012.

The structure and function of this battery assembly in the present embodiment may be consistent with the corresponding structure in the previous embodiment, and will not be repeated in this embodiment.

The controller 202 may include a detection unit 2021 and a control unit 2022.

The detection unit 2021 may be used to detect the voltage difference between the at least two batteries.

The control unit 2022 may be used to determine a target connection mode based on the operating states and the voltage difference.

In some embodiments, the detection unit may be used to detect the voltage difference between the at least two batteries.

For example, the detection unit may first detect the voltage across each battery to determine the voltage value of each battery, and then subtract the voltage values of each battery to obtain the voltage difference between the at least two batteries.

The control unit may obtain the current operating states of the at least two batteries, for example, whether they are charging or discharging.

In some embodiments, the operating states of all batteries in the battery assembly may be the same.

The control unit may determine the target connection mode based on the current operating states of and the voltage difference between the at least two batteries.

The voltage difference between the at least two batteries may represent their actual operating states. A large voltage difference may indicate an inconsistency in their actual operating states. When controlling the connection mode, this inconsistency may be considered, and the determined target connection mode may resolve this inconsistency, reducing the overall power consumption of the electronic device.

For example, the control unit may obtain a control strategy of the electronic device. The strategy may determine the initial target connection mode based on the operating states of the at least two batteries. Based on this control strategy, the voltage difference between at least two batteries may also be considered for balance control to determine the final target connection mode. This target connection mode may balance the voltage difference between the at least two batteries, match their operating states, and achieve higher charging efficiency and higher power supply efficiency for the system.

When the voltage difference between the at least two batteries is small, no balance control may be needed, and a first connection mode corresponding to the control strategy may be used. When the voltage difference between the at least two batteries is large, balance control may be required, and the target connection mode different from the first connection mode corresponding to the control strategy may be determined to balance the battery voltage and reduce power consumption.

It should be noted that the process of determining the target connection mode will be described in detail in subsequent method embodiments, and will not be detailed in this embodiment.

In the electronic device provided in this embodiment, the controller may include: a detection unit and a control unit. The detection unit may be used to detect the voltage difference between at least two batteries; and the control unit may be used to determine the target connection mode based on the operating state and the voltage difference. In this embodiment, the detection unit may detect the voltage difference between the at least two batteries, and the control unit may determine the target connection mode based on the operating states of and the voltage difference between the at least two batteries. This target connection mode may combine the operating states of and the voltage difference between the at least two batteries. Connecting the at least two batteries based on this target connection mode may achieve the determination of the target connection mode according to the operating states of the at least two batteries and the actual situation of the operating states, and controlling each battery to adopt the targeted connection mode, which may reduce the overall power consumption of the electronic device.

In another embodiment, the electronic device may include a battery assembly and a controller.

The controller may include: a detection unit and a control unit.

The structure and function of the controller may be consistent with the corresponding structure in the previous embodiments, and will not be repeated in this embodiment.

As shown in FIG. 3, which is a schematic diagram of the battery assembly in this embodiment, the battery assembly may include at least two batteries and a switching component.

For example, the battery assembly may include: a first battery S1 and at least one second battery S2~Sn, where n may be an integer greater than 1.

The switching component may include a plurality of switches SW.

The negative terminal of the first battery S1 may be grounded, and the negative and positive terminals of the first battery S1 may be connected in parallel through a first switch SW1.

That at least one second battery S2~Sn may be connected in series (to form a second battery series) through at least one second switch SW2. The negative terminal of each second battery may be grounded through a corresponding third switch SW3, and the negative terminal of the second switch series may be connected to the positive terminal of the first battery through a fourth switch SW4. A fifth switch SW5 may be connected between the positive and negative terminals of each second battery. The positive terminal of the second battery series may be connected to a voltage output terminal, and the negative terminal of the second battery series may be grounded through the third switch SW3. It should be noted that the negative terminal of each second battery may be grounded through a corresponding third switch SW3, and the opening and closing of each third switch SW3 may be controlled by the control unit.

In this embodiment, the negative terminal of each battery may be grounded through a corresponding switch, achieving separate grounding when the at least two batteries are connected in parallel. Furthermore, the positive and negative terminals of each battery may be connected through separate switches, and the at least two batteries may be connected in series through switches sequentially, such that the series or parallel connection of the at least two batteries may be achieved by opening and closing the switches.

In the electronic device provided by the present embodiment, the battery assembly may include: a first battery and at least one second battery. The switching component may include a plurality of switches. The negative terminal of the first battery may be grounded, and the negative and positive terminals of the first battery may be connected in parallel through a first switch. The at least one second battery may be connected in series through at least one second switch, and the negative terminal of each second battery may be grounded through a corresponding third switch. The negative terminal of the second switch series may be connected to the positive terminal of the first battery through a fourth switch, and a fifth switch may be connected between the positive and negative terminals of each second battery. The positive terminal of the second battery series may be connected to a voltage output terminal, and the negative terminal of the second battery series may be grounded through a third switch. In this embodiment, the negative terminal of each battery may be grounded via a corresponding switch, and the positive and negative terminals of each battery may be connected via switches, respectively. The at least two batteries may also be connected in series via switches, allowing for series or parallel connection of the at least two batteries by opening and closing the switches. This may provide a device foundation for controlling the at least two batteries of the battery assembly to be connected in the target connection mode based on the control unit.

In another embodiment, the electronic device may include a battery assembly and a controller.

The structure and function of the battery assembly may be consistent with the corresponding structure in the previous embodiments, and will not be repeated in this embodiment.

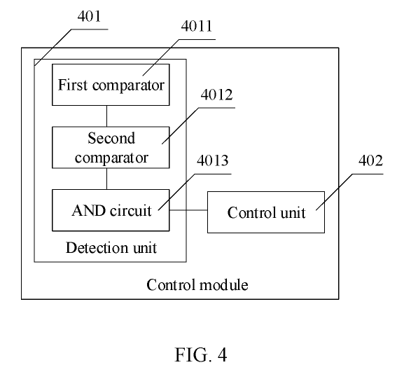

As shown in FIG. 4, which is a schematic diagram of the controller according to the present disclosure, the controller may include a detection unit 401 and a control unit 402.

The detection unit 401 may include a first comparator 4011, used to compare the voltage difference between the first battery and the at least one second battery.

In one embodiment, the first comparator may be implemented using a plurality of comparison units (buf), where each battery corresponds to one comparison unit. The two input terminals of each comparison unit may be connected to the positive and negative terminals of one corresponding battery, respectively. The voltage across the battery may be detected, and the battery voltage may be determined based on this voltage. Another comparison unit may be then set up to compare the battery voltage with the voltages of other comparison units to obtain the voltage difference between the at least two batteries.

A second comparator 4012 may be used to compare the voltage difference with a preset voltage threshold range. When the voltage difference does not fall within the preset voltage threshold range, a first signal may be output to the circuit.

The second comparator may have a voltage threshold range, which includes an upper limit and a lower limit.

For example, the upper limit of this voltage threshold range may be positive, and the lower limit may be negative, to ensure that the voltage difference between the at least two batteries is not limited by whether the value is positive or negative.

For example, the upper limit may be +20 mV (millivolts), and the lower limit may be -20 mV.

When the voltage difference output by the first comparator is within the preset voltage threshold range, no first signal may be output to the circuit, such that the at least two batteries maintain their current connection and the connection mode is not switched.

When the voltage difference output by the first comparator is not within the preset voltage threshold range, indicating that the voltage difference between the at least two batteries is large during the current charging/discharging process and adjustment of the battery charging/discharging may be required. Therefore, the second comparator may output the first signal to the circuit when the voltage difference is not within the preset voltage threshold range.

For example, this first signal may be a low voltage level.

The second comparator may be implemented using two comparison units. One comparison unit may be used to set the upper limit value of the preset voltage threshold range, and the other may be used to set the lower limit value. The output terminal of the first comparator may be connected to one input terminal of each of the two comparison units of the second comparator. When the voltage difference is larger than the upper limit value of the comparison unit, the comparison unit may output the first signal. When the voltage difference is less than the lower limit value of the other comparison unit, the comparison unit may also output the first signal.

Correspondingly, the control unit 402 may include:

an AND circuit 4021, with one input terminal connected to the output terminal of the second comparator, and another input terminal connected to a system terminal signal. This circuit may generate the first control signal based on the first signal and the system terminal signal. The first control signal may control the connection mode of the at least two batteries within the battery assembly. The system terminal signal may characterize the system control strategy corresponding to the operating states.

The first comparator may compare the voltages of each battery. For example, it may compare the voltages of the first battery and the at least two second batteries to obtain the voltage difference between the at least two batteries.

The AND circuit may include two input terminals. One input terminal may be connected to the output terminal of the second comparator, for receiving the signal output by the second comparator. The other input terminal may be connected to the system terminal signal. Based on the first signal and the system terminal signal, the AND circuit may generate the first control signal.

The system terminal signal may represent a system control strategy characterizing the operating states of the least two batteries. For example, the AND circuit may determine the battery connection mode based on the first control signal and the system control strategy, generating the first control signal to control the battery connection mode within the battery assembly.

The control of the battery connection mode based on the control strategy will be described in detail in subsequent method embodiments and will not be detailed in this embodiment.

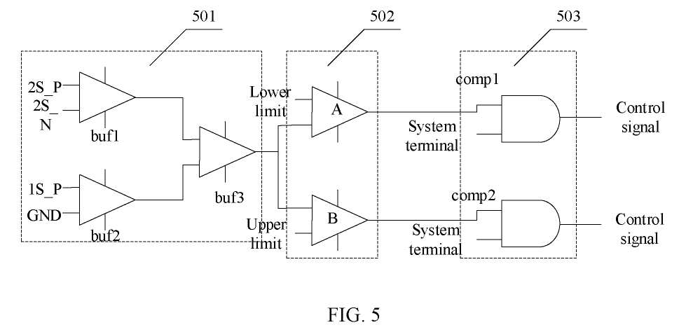

In another embodiment, as shown in FIG. 5 which is another structural schematic diagram of the controller, the controller may include a first comparator 501, a second comparator 502, and an AND circuit 503. The first comparator may include comparison units buf1, buf2, and buf3; the second comparator may include comparison units A and B; and the AND circuit 503 may include AND circuits comp1 and comp2. In this embodiment, the controller may correspond the electronic device with two batteries, S1 and S2. The negative terminal of the battery S1 may be grounded, and its positive terminal may be connected to the negative terminal of the battery S2. The two input terminals of the comparison unit buf1 may be connected to the two terminals of the battery S2 (a positive terminal 2S_P, a negative terminal 2S_N), and the two input terminals of the comparison unit buf2 may be connected to the two terminals of the battery S1 (a positive terminal 1S_P, a negative terminal grounded GND). The output terminals of the comparison units buf1 and buf2 may be connected to the input terminals of the comparison unit buf3, respectively, and the input terminal of the comparison unit buf3 may be connected to one input terminal of the comparison units A and B respectively. Another input terminal of the comparison unit A may set the lower limit (negative value) of the preset voltage threshold range, and another input terminal of the comparison unit B may set the upper limit (positive value) of the preset voltage threshold range. The output terminal of the comparison unit A may be connected to one input terminal of the AND circuit comp1, and the other input terminal of the AND circuit comp1 may be connected to the system terminal to receive the system terminal signal. The output terminal of this AND circuit may output a control signal to control the switching action of the battery assembly. Similarly, the output terminal of the comparison unit B may be connected to one input terminal of the AND circuit comp2, and the other input terminal of the AND circuit comp2 may be connected to the system terminal to receive the system terminal signal. The output terminal of this AND circuit comp2 may output a control signal to control the switching action of the battery assembly.

In the electronic device provided by the present embodiment, the detection unit may include: a first comparator for comparing the voltage difference between a first battery and at least one second battery; a second comparator for comparing the voltage difference with the preset voltage threshold range and outputting a first signal to an AND circuit if the voltage difference does not fall within the preset voltage threshold range; and the AND circuit, with one input terminal connected to the output terminal of the second comparator and the other input terminal connected to a system terminal signal, for generating a first control signal based on the first signal and the system terminal signal. The first control signal may be used to control the connection mode of the at least two batteries within the battery assembly, and the system terminal signal may be used to characterize a system control strategy corresponding to the operating states. In this embodiment, the detection unit may include a first comparator, a second comparator, and an AND circuit. The first comparator may be used to compare the voltage difference between the at least two batteries, and the second comparator may be used to compare the voltage difference with the preset voltage threshold range. When the voltage difference does not fall within the preset voltage threshold range, a first signal may be output to the AND circuit, and the AND circuit may generate a control signal based on the first signal and the system terminal signal, such that the system control strategy based on the operating states controls the connection mode of the at least two batteries in conjunction with the operating states of the at least two batteries.

In another embodiment, the electronic device may include a battery assembly and a controller.

The controller may include a detection unit and a control unit.

The structure and function of the controller may be consistent with the corresponding structure in previous embodiments, and will not be described again in this embodiment.

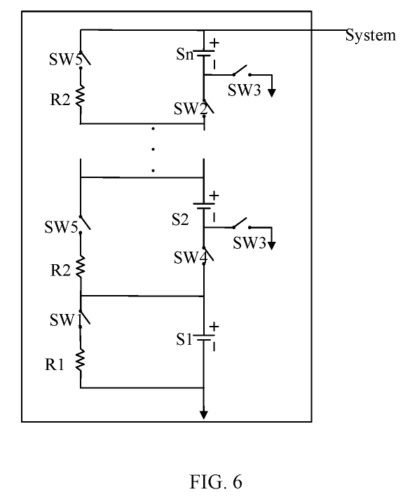

As shown in FIG. 6 which shows a schematic diagram of the battery assembly in the electronic device provided by the present embodiment, the battery assembly may include at least two batteries and a switching component.

The battery assembly may include a first battery S1 and at least one second battery S2-Sn.

The switching component may include a plurality of switches SW.

The structure and function of the at least two batteries and the switching component in this battery assembly may be consistent with the corresponding structure in previous embodiments, and will not be described again in this embodiment.

The battery assembly may further include:

a first current-limiting unit R1, connected in parallel between the positive and negative terminals of the first battery, and connected in series with the first switch; and

at least one second current-limiting unit R2, connected in parallel between the positive and negative terminals of the at least one second battery, and connected in series with the fifth switch.

Each battery may be connected in parallel with a current-limiting unit, which may be connected and disconnected from the corresponding battery via a corresponding switch.

The first current-limiting unit may be connected in series with the first switch. When the first switch is closed, the first current-limiting unit may be connected in parallel with the first battery; and, when the first switch is open, the first current-limiting unit may be not connected to the two terminals of the first battery.

One second current-limiting unit may be connected in series with one corresponding fifth switch. When the fifth switch is closed, the second current-limiting unit may be connected in parallel with one corresponding second battery; and, when the fifth switch is open, the second current-limiting unit may be disconnect from the battery assembly and may be not connected to the two terminals of the corresponding second battery.

The first current-limiting unit and the at least one second current-limiting unit may be used when the voltage difference between the at least two batteries is large and outside the preset voltage threshold range. This may require adjusting the actual operating states of the at least two batteries. The current-limiting units may adjust the input current or output current of the at least two batteries to match the operating states of the at least two batteries, achieving higher charging efficiency and higher power supply efficiency for the system.

It should be noted that the connection or disconnection of the current-limiting units may be related to the operating states of the at least two batteries and match with the target connection mode of the at least two batteries.

In the present embodiment, the electronic device may include a battery assembly that further includes: a first current-limiting unit connected in parallel between the positive and negative terminals of the first battery and connected in series with the first switch; and at least one second current-limiting unit connected in parallel between the positive and negative terminals of the at least one second battery, the second current-limiting unit being connected in series with the fifth switch. In this embodiment, the battery assembly may further include one current-limiting unit connected in parallel with one corresponding battery, such that the actual operating states of the at least two batteries may be adjusted through the corresponding current-limiting units to match the operating states of the at least two batteries, achieving higher charging efficiency and higher power supply efficiency to the system.

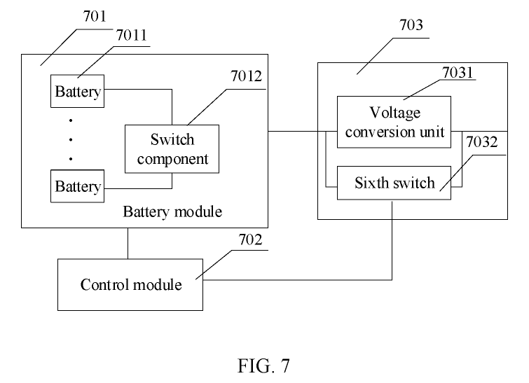

In another embodiment, as shown in FIG. 7 which is a schematic diagram of another electronic device according to the present disclosure, the electronic device may include a battery assembly 701, a controller 702, and a voltage conversion module 703.

The battery assembly 701 may include at least two batteries 7011 and a switching component 7012.

The structure and function of this battery assembly may be consistent with the corresponding structure in previous embodiments, and will not be repeated in this embodiment.

The voltage conversion module 703 may include a voltage conversion unit 7031 and a sixth switch 7032. The sixth switch may be connected in parallel between the input and output terminals of the voltage conversion unit.

The sixth switch may be open when the at least two batteries are connected in series and closed when the at least two batteries are connected in parallel.

The voltage conversion unit may be used to convert the supply voltage output by the at least two batteries connected in series in a discharging state to the system load into a voltage that meets the system load’s power supply conditions, and to convert the charging voltage received by the at least two batteries connected in series in a charging state into a voltage required for charging.

The electronic device may also include the voltage conversion module, which includes the voltage conversion unit. The voltage conversion unit may convert the input or output voltage of the system into a voltage that meets the charging requirements or the power supply conditions of the system load.

When the at least two batteries are connected in series, the supply voltage they provide to the system load may be the sum of the voltages of the at least two batteries connected in series. This supply voltage may be greater than the voltage requirement of the system load. Therefore, the voltage conversion unit may convert the supply voltages of the at least two batteries connected in series into a voltage that meets the power supply conditions of the system load.

When the at least two batteries are connected in series, during charging, the received charging voltage may be less than the total voltage required by the at least two batteries connected in series. Therefore, the voltage conversion unit may convert the charging voltage into a voltage that meets the charging requirements of the at least two batteries connected in series, thus achieving the purpose of charging the at least two batteries connected in series.

The voltage conversion module may also include the sixth switch connected to the input terminal and the output terminal of the voltage conversion unit. This sixth switch may be configured to control whether the voltage conversion unit is connected to the operating circuit of the electronic device.

For example, when the sixth switch is open, the voltage conversion unit may be connected to the operating circuit and perform voltage conversion. When the sixth switch is closed, the voltage conversion unit may be short-circuited and may be not connected to the operating circuit.

When the target connection mode of the at least two batteries in the battery assembly of the electronic device is parallel, and the output voltage matches the input voltage of the system load, the voltage conversion unit may not need to perform voltage conversion. Accordingly, the sixth switch may be closed, and the voltage conversion unit may be short-circuited. When the target connection mode of the at least two batteries is series, the voltage conversion unit may need to perform voltage conversion. Accordingly, the sixth switch may be opened, and the voltage conversion unit may be connected to the operating circuit.

The electronic device provided by the present embodiment may further include: a voltage conversion module including a voltage conversion unit and a sixth switch. The sixth switch may be connected in parallel between the input and output terminals of the voltage conversion unit. The sixth switch may be open when at least two batteries may be connected in series and closed when at least two batteries may be connected in parallel. The voltage conversion unit may be used to convert the supply voltage output by the at least two batteries connected in series to the system load when in a discharging state into a voltage that meets the system load supply conditions, and to convert the charging voltage received by the at least two batteries connected in series when in a charging state into a voltage required for charging. In this embodiment, the electronic device may be further provided with a voltage conversion module, where voltage conversion unit may convert the supply voltage output by the at least two batteries connected in series to the system load when in a discharging state into a voltage that meets the system load supply conditions, and convert the charging voltage received by the at least two batteries connected in series when in a charging state into a voltage required for charging. Moreover, the circuit for connecting and disconnecting the voltage conversion unit may be realized through the sixth switch, which may control the connection and disconnection state of the voltage conversion unit according to the battery connection state, ensuring charging and discharging safety.

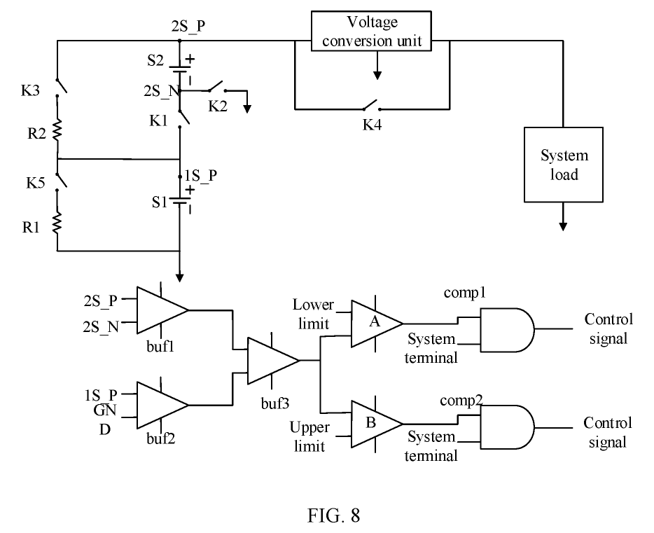

In another embodiment shown in FIG. 8 which is a schematic diagram of an electronic device, the electronic device may include two batteries S1 and S2, a voltage conversion unit, a controller, switches K1-K5, current-limiting resistors R1-R2, and a system load.

The battery S1 may have its negative terminal grounded, and its positive terminal connected to the negative terminal of the battery S2 via the switch K1. The negative terminal of the battery S2 may be grounded via the switch K2. The current-limiting resistor R1 may be connected in parallel with the battery S2 via the switch K3, and the current-limiting resistor R2 may be connected in parallel with the battery S1 via the switch K5. The positive terminal of the battery S2 may be adjacent to one terminal of the voltage conversion unit, and the other terminal of the voltage conversion unit may be connected to the system load. The voltage conversion unit may be connected in parallel with the switch K4. The voltage detection point 1S_P may be set at the positive terminal of the battery S1 and the battery S2, and the voltage detection point 1S_N may be set at the negative terminal of the battery S2.

The controller may include comparison units buf1, buf2, buf3, comparison units A and B, and circuits comp1 and comp2. The two input terminals of the comparison unit buf1 may be connected to the two terminals of the battery S2 (a positive terminal 2S_P and a negative terminal 2S_N) respectively, and the two inputs of the comparison unit buf2 may be connected to the two terminals of the battery S1 (a positive terminal 1S_P and a negative terminal ground GND) respectively. The output terminals of the comparison units buf1 and buf2 may be connected to the input terminal of the comparison unit buf3, which in turn may be connected to one input terminal of the comparison units A and B. The other input terminals of the comparison unit A may set the lower limit (a negative value) of the preset voltage threshold range, and the other input terminal of the comparison unit B may set the upper limit (a positive value) of the preset voltage threshold range. The output terminal of the comparison unit A may be connected to one input terminal of the AND circuit comp1, and the other input terminal of the AND circuit comp1 may be connected to the system terminal to receive the system terminal signal. The output terminal of the AND circuit comp1 may output a control signal to control the switch operation. The output terminal of the comparison unit B may be connected to one input terminal of the AND circuit comp2, and the other input terminal of the AND circuit comp2 may be connected to the system terminal to receive a system terminal signal. The output terminal of the AND circuit comp2 may output a control signal to control the switch operation.

Corresponding to the above-described embodiments of the electronic device provided by the present disclosure, the present disclosure also provides a battery balance control method applied to the electronic device.

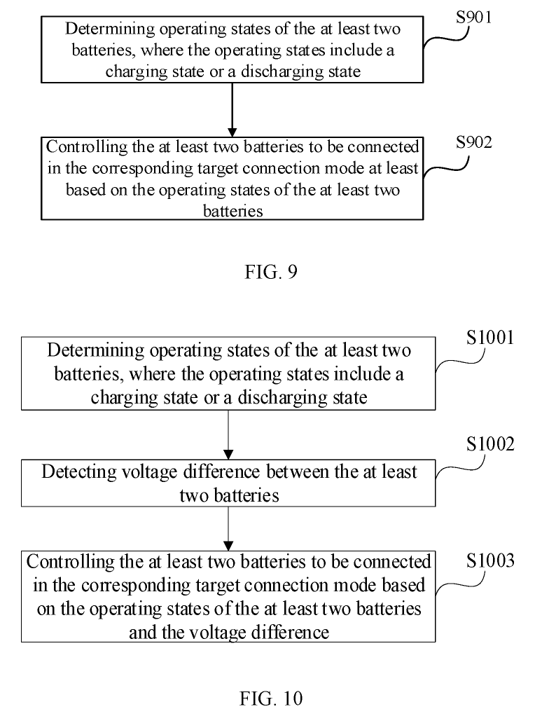

In one embodiment, as shown in FIG. 9 which is a flowchart of a battery balance control method provided by the present disclosure, the battery balance control method may be applied to an electronic device including at least two batteries, and may include S901 to S902.

At S901, the operating states of the at least two batteries may be obtained, where the operating states may be a charging state or a discharging state.

The operating states of the at least two batteries may be determined by monitoring the current flow direction at two terminals of the at least two batteries, or by other methods. The present disclosure does not limit the specific method for determining the operating states of the at least two batteries.

The operating states of the at least two batteries may include a charging state or a discharging state.

At S902: based at least on the operating states of the at least two batteries, the at least two batteries may be controlled to be connected in a corresponding target connection mode, where the target connection mode may include a parallel connection or a series connection.

Based on the operating states of the at least two batteries, the target connection mode corresponding to those operating states may be determined to control the at least two batteries to be connected in the target connection mode. This target connection mode may be one of parallel connection or series connection. The at least two batteries may be controlled to be connected in different connection modes based on their operating states, such that the battery connection mode matches the operating states of the at least two batteries. When the battery connection mode does not match the operating states, it may lead to different battery output voltages or different battery input voltages. To balance the voltages, this may result in increased power consumption. In this embodiment, the battery connection mode may match the operating states of the at least two batteries, which may reduce the power consumption of the electronic device.

During charging, if the at least two batteries are in the first stage of charging (a trickle charge stage), the target connection mode may be series or parallel; when the at least two batteries is in the second stage of charging (a constant current stage), the target connection mode may be series; or when the at least two batteries is in the third stage of charging (a constant voltage stage), the target connection mode may be parallel.

During discharging, when the system load is light, the target connection mode may be parallel; or, when the system load is heavy, the target connection mode may be series.

The battery balance control method applied to an electronic device including at least two batteries and provided by the present embodiment, may include: determining the operating states of the at least two batteries, where the operating states include a charging state or a discharging state; and controlling the at least two batteries to be connected in the corresponding target connection mode, including parallel or series, based at least on the operating states of the at least two batteries. In this embodiment, based on whether the at least two batteries are in a charging state or connected in series, the at least two batteries may be connected in the target connection mode, which may include at least one of parallel and series connections. This may realize the switching of different connection modes according to the operating states of the at least two batteries, which may reduce the overall power consumption of the electronic device.

In another embodiment, as shown in FIG. 10 which is a flowchart of another battery balance control method consistent with the present disclosure, the method may include S1001 to S1003.

At S1001: the operating states of the at least two batteries may be determined, where the operating states may include a charging state or a discharging state.

S1001 is consistent with the corresponding step in the previous embodiments and will not be repeated in this embodiment.

At S1002: the voltage difference between the at least two batteries may be detected.

The voltage of each battery in the at least two batteries of the electronic device may be detected to determine the voltage difference between the at least two batteries.

For the connection mode of the at least two batteries, references may be made to the previous embodiments of the electronic device, and will not be repeated in this embodiment.

The voltage value across each battery may be detected separately, and the voltage of each battery may be determined based on the detected voltage value, thereby calculating the voltage difference between the at least two batteries.

In some embodiments, a comparison unit may be set for each battery to detect the voltage value across the corresponding battery in the circuit, and the comparison unit may output the voltage of that battery.

In some embodiments, a comparison unit may be set up to compare the voltage of each battery to obtain the voltage difference.

It should be noted that the order of the two steps—determining the voltage difference between the at least two batteries and determining the operating states of the at least two batteries, is not limited to the order shown in this embodiment, and they can be executed simultaneously or in any order.

At S1003: based on the operating states of the at least two batteries and the voltage difference, the at least two batteries may be controlled to be connected in a corresponding target connection mode.

By combining the operating states of the at least two batteries and the voltage difference between the at least two batteries, the target connection mode may be determined, and then the at least two batteries may be controlled to be connected in the corresponding target connection mode, such that the battery connection mode matches the operating states of and the voltage difference between the at least two batteries. This target connection mode may be determined based on the initial target connection mode determined by the target state in the system strategy, and then adjusted by considering the voltage difference and performing voltage balance control to form the final target connection mode.

It should be noted that the process of controlling the at least two batteries to connect in the corresponding target connection mode will be described in detail in subsequent embodiments; it will not be detailed in this embodiment.

In the present embodiment, the battery balance control method, may include: detecting the voltage difference between the at least two batteries; and controlling the at least two batteries to be connected in the corresponding target connection mode based on the operating states of the at least two batteries and the voltage difference between the at least two batteries. In this embodiment, by controlling the at least two batteries to be connected in the corresponding target connection mode based on the voltage difference between the at least two batteries in the electronic device and the operating states of the at least two batteries, the battery connection mode may match the operating states of the at least two batteries and the voltage difference between the at least two batteries, achieving the switching of different connection modes according to the operating states of the at least two batteries and thereby reducing the overall power consumption of the electronic device.

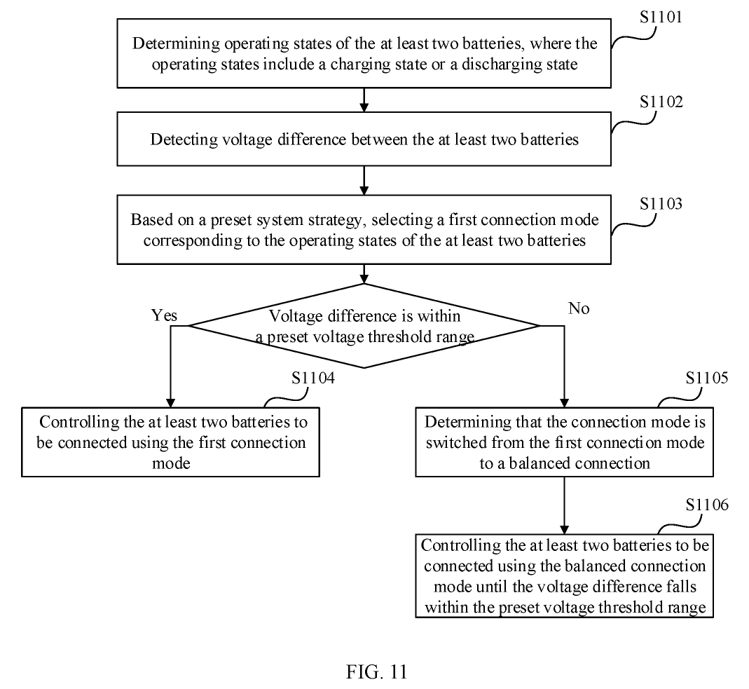

In another embodiment, as shown in FIG. 11 which is a flowchart of another battery balance control method consistent with the present disclosure, the method may include S1101 to S1106.

At S1101: the operating states of the at least two batteries may be determined, where the operating states may include a charging state or a discharging state.

At S1102: the voltage difference between the at least two batteries may be detected.

S1101 and S1102 are consistent with the corresponding step in the previous embodiments and will not be repeated in this embodiment.

At S1103, based on a preset system strategy, a first connection mode corresponding to the operating states of the at least two batteries may be selected.

The electronic device may have a system strategy that sets different connection modes for different battery operating states.

Based on the operating states of the at least two batteries, a corresponding connection mode may be selected as the first connection mode from the system strategy.

It should be noted that this first connection mode may be an initial target connection mode determined based on the preset system strategy. In this embodiment, the final target connection mode may be a balancing connection mode obtained by adjusting the initial target connection mode by combining the voltage difference and comprehensively considering the voltage difference between the at least two batteries for voltage balance control.

At S1104, when the voltage difference falls within a preset voltage threshold range, the at least two batteries may be controlled to be connected in the first connection mode;

The preset voltage threshold range may include an upper limit and a lower limit. The upper limit may be a positive number, and the lower limit may be a negative number. Values within the preset voltage threshold range may represent smaller voltage differences, while values outside the preset voltage threshold range may represent larger voltage differences.

When the voltage difference falls within the preset voltage threshold range, the power consumption of the at least two batteries with the voltage difference in the operating states may be low and may be ignored.

Correspondingly, based on the first connection mode corresponding to the operating states of the at least two batteries, the power consumption of the at least two batteries with the voltage difference in this first connection mode may be low and can be ignored.

At S1105, when the voltage difference does not fall within the preset voltage threshold range, it may be determined to switch from the first connection mode to a balanced connection mode, which is used to reduce the voltage difference.

Values outside the preset voltage threshold range may represent larger voltage differences, and correspondingly, the power consumption of the at least two batteries with the voltage difference in the operating states may be higher, requiring adjustment.

The first connection mode for battery connection may be switched to a balanced connection mode, which is used to reduce the voltage difference between the at least two batteries.

At S1106, the at least two batteries may be controlled to be connected in the balanced connection mode until the voltage difference falls within the preset voltage threshold range, and then switch back to the first connection mode.

By controlling the battery connection in the balanced connection mode to reduce the voltage difference between the at least two batteries, and then switching back to the first connection mode once the voltage difference between the at least two batteries falls within the preset voltage threshold range, the battery connection mode may be adjusted to match the actual operating states, thereby reducing the overall power consumption of the electronic device.

In the present embodiment, the battery balance control method may include: selecting a first connection mode corresponding to the operating states of the at least two batteries based on a preset system strategy; when the voltage difference is within a preset voltage threshold range, controlling the at least two batteries to be connected in the first connection mode; when the voltage difference is not within the preset voltage threshold range, determining to switch from the first connection mode to a balancing connection mode; and controlling the at least two batteries to be connected in the balancing connection mode until the voltage difference is within the preset voltage threshold range, and then switching back to the first connection mode. The balancing connection mode may be used to reduce the voltage difference. In this embodiment, a first connection mode corresponding to the operating states of the at least two batteries may be first selected based on a preset system strategy. If the voltage difference between the at least two batteries is within a preset voltage threshold range, the at least two batteries may be controlled to be connected in the first connection mode. If the voltage difference between the at least two batteries is not within the preset voltage threshold range, it may be determined to switch from the first connection mode to a balancing connection mode, and the at least two batteries may be controlled to be connected in the balancing connection mode, which is used to reduce the voltage difference between the at least two batteries, until the voltage difference between the at least two batteries is within the preset voltage threshold range, and then switching back to the first connection mode. Therefore, the battery connection mode may match the actual operating states, thereby reducing the overall power consumption of the electronic device.

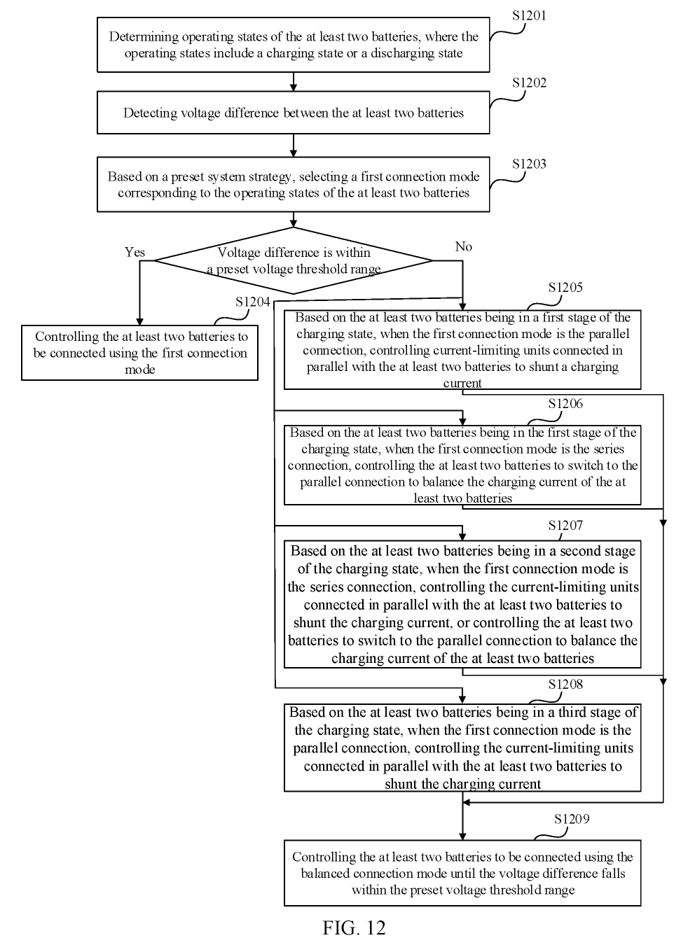

In another embodiment, as shown in FIG. 12 which is a flowchart of another battery balance control method consistent with the present disclosure, the method may include S1201 to S1209.

At S1201: the operating states of the at least two batteries may be determined, where the operating states may include a charging state or a discharging state.

At S1202: the voltage difference between the at least two batteries may be detected.

At S1203, based on a preset system strategy, a first connection mode corresponding to the operating states of the at least two batteries may be selected.

At S1204, when the voltage difference falls within a preset voltage threshold range, the at least two batteries may be controlled to be connected in the first connection mode.

S1201 to S1204 may be consistent with the corresponding step in the previous embodiments and will not be repeated in this embodiment.

This embodiment describes the scenario where at least two batteries may be in a charging state.

At S1205, based on the at least two batteries being in the first stage of the charging state, if the first connection mode is parallel and the voltage difference is not within a preset voltage threshold range, the current limiting units connected in parallel with the at least two batteries may be controlled to shunt the charging current, where the battery charging current in the first stage may be less than a preset current threshold.

In some embodiments, the first stage of the charging state, where the battery charging current may be less than the preset current threshold, may be the trickle charging stage.

When the at least two batteries are in the trickle charging stage and the first connection mode is parallel, if the voltage difference between the at least two batteries is not within the preset voltage threshold range (indicating a large voltage difference), balance control may be required. For example, this may involve controlling the current limiting units connected in parallel with the at least two batteries to shunt the charging current. If the voltage difference between the at least two batteries is within the preset voltage threshold range (indicating a small voltage difference), the first connection mode may be maintained, and balance control may be not required.

In some embodiments, the switches connected in series with the current-limiting units may be closed, allowing the current-limiting units to be connected in parallel with a higher-voltage battery, thus diverting the charging current to the higher-voltage battery.

As shown in the electronic device shown in FIG. 8, if the batteries are in the trickle charging stage and the batteries S1 and S2 are initially connected in parallel, the switches K2 and K3 may be closed, while other switches may be open. If the voltage difference between the batteries S1 and S2 is not within a preset voltage threshold range, and the voltage of the battery S1 is larger than that of the battery S2, the balance control method may include closing the switches K2, K3, and K5, while other switches may be open, allowing the current-limiting unit R2 to be connected in the circuit to divert the charging current from the battery S1.

At S1206, based on the at least two batteries being in the first stage of the charging state, if the first connection mode is series and the voltage difference is not within a preset voltage threshold range, the at least two batteries may be controlled to switch to parallel connection to balance the charging currents of the at least two batteries;

For example, when the at least two batteries are in the trickle charging stage and the first connection mode is series, if the voltage difference between the at least two batteries is not within the preset voltage threshold range, indicating a large voltage difference between the at least two batteries, the at least two batteries may be controlled to switch to parallel connection to balance the charging current of each battery.

For example, the switches connected in series between the at least two batteries may be controlled to open, and the switches between each battery and ground may be controlled to close, such that the at least two batteries switch to the parallel connection, and limit the charging current by adjusting the current-limiting resistors R1/R2.

For example, for the electronic device shown in FIG. 8, when the batteries are in the trickle charging stage and the batteries S1 and S2 are initially connected in series, the switches K1 and K4 may be closed, while other switches may be open. If the voltage difference between the batteries S1 and S2 is not within the preset voltage threshold range, and the voltage of S1 is larger than that of S2, the balance control method may include switching the two batteries to a parallel connection, closing the switches K2 and K3, opening other switches, and continuing to monitor the battery voltage difference.

It should be noted that if the series connection of the at least two batteries is not switched to a parallel connection, the balance control method may directly add a bypass to the high-voltage battery S1 to achieve current shunting, such as closing the switches K2, K3, and K5 to shun the current flowing into the battery S1. This shunted current may be consumed by R2, resulting in wasted system power. Therefore, in this embodiment, the at least two batteries may be switched from a series connection to a parallel connection to achieve voltage balancing and reduce power loss.

If the voltage difference between the at least two batteries is within the preset voltage threshold range, indicating a small voltage difference, the first connection mode may be maintained, and balance control may not be required.

At S1207: based on the at least two batteries being in the second stage of the charging state, if the first connection mode is series and the voltage difference does not fall within the preset voltage threshold range, the current limiting units connected in parallel with the at least two batteries may be controlled to shunt the charging current; or control the at least two batteries to switch to a parallel connection, where the charging currents of the at least two batteries in the second stage may be larger than the preset current threshold.

In the second stage of the charging state, the charging currents of the at least two batteries may be larger than the preset current threshold. For example, the second stage may be a constant current stage during the charging process.

When the at least two batteries are in the constant current stage of the charging state, the first connection mode may be series connection, which may increase the charging voltage and improve charging efficiency.

In some embodiments, if the voltage difference between the at least two batteries does not fall within the preset voltage threshold range, indicating a large voltage difference between the at least two batteries, the current limiting units connected in parallel with the at least two batteries may be controlled to shunt the charging current. For example, the switch of the current limiting unit connected in parallel with a battery with the higher voltage may be closed, so that the current limiting unit may be connected to the circuit, making it connected in parallel with the battery with the higher voltage in the circuit, thereby shunting the charging current for the higher voltage battery.

As shown in the electronic device shown in FIG. 8, if the batteries are in the constant current stage of charging, and the first connection mode of the batteries S1 and S2 is in series, the switches K1 and K4 of the electronic device may be closed, and the other switches may be open. If the voltage difference between S1 and S2 is not within the preset voltage threshold range, and the voltage of S1 is larger than that of S2, K1, K4, and K5 may be controlled to close, such that the current limiting unit R2 may be connected in parallel with the battery S1, and R2 may shunt the charging current of the battery S1.

In other embodiments, when the at least two batteries are in the constant current charging stage, and the first connection mode is determined to be series, but the voltage difference between the at least two batteries does not fall within the preset voltage threshold range, indicating a large voltage difference between the at least two batteries, the battery connection mode may be switched to parallel to balance the charging current of each battery. For example, the switch connecting the at least two batteries in series may be opened, and the switch between each battery and ground may be closed, such that the at least two batteries may be switched to a parallel connection.

As an example, for the electronic device shown in FIG. 8, when the at least two batteries are in the constant current charging stage, and the first connection mode of the batteries S1 and S2 is series, the switches K1 and K4 of the electronic device may be closed, and other switches may be open. When the voltage difference between the batteries S1 and S2 does not fall within the preset voltage threshold range, and the voltage of the battery S1 is larger than that of the battery S2, the two batteries may be switched to parallel connection, and the switches K2 and K3 may be closed, while other switches may be open.

It should be noted that, in the above embodiments, when the at least two batteries are connected in series, the voltage conversion unit may need to be enabled. For the electronic device shown in FIG. 8, as an example, the control switch K4 may be opened. When the at least two batteries are connected in parallel, the voltage conversion unit may not be activated. For the electronic device shown in FIG. 8, as an example, the control switch K4 may be closed, bypassing the voltage conversion unit.

In other embodiments, in the second stage (constant voltage stage) of the battery charging state, when the first connection mode is series, if the voltage difference is within the preset voltage threshold range, the battery connection mode may not be switched, and the series connection may be maintained.

At S1208, based on the at least two batteries being in the third stage of the charging state, when the first connection mode is parallel and the voltage difference is not within the preset voltage threshold range, the current limiting unit connected in parallel with the at least two batteries may be controlled to shunt the charging current, and the charging voltage of the at least two batteries may be fixed in the third stage.

In the third stage of the charging state, the charging voltage of the at least two batteries may be fixed, and the third stage of the charging state may be the constant voltage stage during the charging process.

In this process, when the at least two batteries are in the constant voltage stage of the charging state, the charging voltage may be stable and relatively low. Preferably, the first connection mode may be a parallel connection.

When the voltage difference between the at least two batteries is not within the preset voltage threshold range, indicating a large voltage difference, the voltage may eventually balance because of the parallel connection. Only the current-limiting units connected in parallel with the at least two batteries may need to be controlled to divert the charging current.

For example, the switches connecting the current-limiting units in series may be closed, allowing the current-limiting units to be connected in parallel with the at least two batteries, thus diverting the charging current to the at least two batteries.

At S1209: the at least two batteries may be connected in the balanced connection mode until the voltage difference falls within the preset voltage threshold range, then the connection may be switched back to the first connection mode.

When the first connection mode is series, switching to the balanced mode may result in the parallel connection. Once the voltage difference between the at least two batteries falls within the preset voltage threshold range, the connection may be switched back to series.

When the first connection mode is parallel, switching to the balancing mode may include connecting a high-voltage battery in parallel with a current-limiting unit. Once the voltage difference between the at least two batteries falls within the preset voltage threshold range, the current-limiting resistors may be disconnected from the parallel connection with the at least two batteries, and the system may switch back to the original first connection mode.

The present embodiment provides a battery balance control method where the at least two batteries are in the charging state. The method may include: based on the at least two batteries being in the first stage of the charging state, when the first connection mode is parallel and the voltage difference does not fall within the preset voltage threshold range, controlling the current-limiting units connected in parallel with the at least two batteries to shunt the charging current, where the charging current of the at least two batteries may be less than a preset current threshold in the first stage; based on the at least two batteries being in the first stage of the charging state, when the first connection mode is series and the voltage difference does not fall within the preset voltage threshold range, controlling the at least two batteries to switch to a parallel connection to balance the voltage difference; based on the at least two batteries being in the second stage of the charging state, when the first connection mode is series and the voltage difference is not within the preset voltage threshold range, controlling the current limiting units connected in parallel with the at least two batteries to shun the charging current or controlling the at least two batteries to switch to the parallel connection, where the charging current of the at least two batteries in the second stage may be larger than the preset current threshold; based on the at least two batteries being in the third stage of the charging state, when the first connection mode is parallel and the voltage difference is not within the preset voltage threshold range, controlling the current limiting units connected in parallel with the at least two batteries to shun the charging current, where the charging voltage of the at least two batteries may be fixed in the third stage. In this embodiment, based on the operating states of the at least two batteries being the charging state, different stages of the charging state and the first connection mode, when the voltage difference is not within the preset voltage threshold range, the connection between the at least two batteries may be controlled to switch to different balancing connection modes to reduce the battery voltage difference.

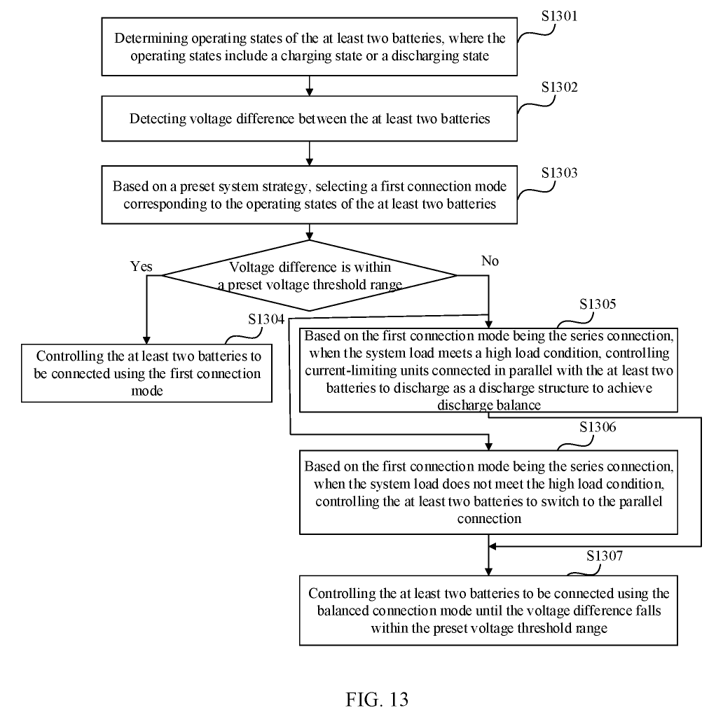

In another embodiment, as shown in FIG. 13 which is a flowchart of another battery balance control method consistent with the present disclosure, the method may include S1301 to S1307.

At S1301: the operating states of the at least two batteries may be determined, where the operating states may include a charging state or a discharging state.

At S1302: the voltage difference between the at least two batteries may be detected.

At S1303, based on a preset system strategy, a first connection mode corresponding to the operating states of the at least two batteries may be selected.

At S1304, when the voltage difference falls within a preset voltage threshold range, the at least two batteries may be controlled to be connected in the first connection mode.

S1301 to S1304 may be consistent with the corresponding step in the previous embodiments and will not be repeated in this embodiment.

This embodiment describes the scenario where the operating states of the at least two batteries are the discharging state.

At S1305: based on the first connection mode being a series connection, when the system load meets the high load condition and the voltage difference is not within the preset voltage threshold range, the current-limiting units connected in parallel with the at least two batteries may be controlled to discharge as a discharge structure to achieve discharge balance.

The system load meeting the high load condition may indicate that the system is operating in a high load mode.

The voltage difference between the at least two batteries not being within the preset voltage threshold range, may indicate that the voltage difference between the at least two batteries is relatively large.

The at least two batteries may be in the discharging state, and the first connection mode may be determined to be a series connection. When the system is operating in the high load mode, although the voltage difference between the at least two batteries may be relatively large, to ensure the load driving capability of the system, the series connection may be maintained. Based on this, voltage balance may be achieved between the at least two batteries. For example, the current-limiting units connected in parallel with the at least two batteries may be controlled to discharge as the discharge structure. For example, the current-limiting unit connected in parallel with the battery with the higher voltage may be connected to the circuit, and discharge may be achieved through this current-limiting unit to achieve discharge balance.

As an example, for the electronic device shown in FIG. 8, when the batteries are in the discharging state and the load is a high load, the preferred first connection mode for the batteries S1 and S2 may be the series connection to provide sufficient load driving capability. Furthermore, the voltage of S1 may be larger than that of S2. In this case, the switches K1 and K4 may be closed, while other switches may be open. The balance control method may include controlling the higher-voltage battery to connect a parallel current-limiting unit, closing the switches K2, K3, and K5, and opening other switches, such that the current-limiting unit R2 is connected to the circuit. R2 may be used for discharging to achieve discharge balance.

At S1306: based on the first connection mode being the series connection, when the system load does not meet the high load condition and the voltage difference is not within the preset voltage threshold range, the at least two batteries may be controlled to switch to the parallel connection.

The system load not meeting the high load condition may indicate that the system is operating in a non-high load mode.

The voltage difference between the at least two batteries not being within the preset voltage threshold range may indicate that the voltage difference between the at least two batteries may be relatively large.

The at least two batteries may be in the discharging state, and the initial connection may be series. If the system operates in a low-load mode, because of the large voltage difference between the at least two batteries, the at least two batteries may be switched to a parallel connection to balance the voltage difference. This parallel connection may ensure balance, meeting load drive requirements under low load conditions without wasting energy.

As an example, for the electronic device shown in FIG. 8, when the batteries are in the discharging state and the load is unloaded, the connection mode for the batteries S1 and S2 is the series connection, and the voltage of S1 is larger than that of S2, the switches K1 and K4 may be closed, while other switches may be open. The balance control method may include controlling the at least two batteries to switch to the parallel connection, closing the switches K2 and K3, and opening other switches, to balance the voltage difference between the at least two batteries.

It should be noted that balancing may also be achieved on a series basis. This balancing method may involve connecting a resistor in parallel to the battery with the higher voltage. The resistor may dissipate the battery’s energy, achieving balance. This balancing method may be the same as the high-load balancing method, but it wastes energy.

It should be noted that when the at least two batteries are connected in series, the voltage conversion unit may need to be enabled. For example, this may be achieved by disabling the sixth switch connected in parallel with the voltage conversion unit. When the at least two batteries may be connected in parallel, the voltage conversion unit may be disabled. For example, this may be achieved by closing the sixth switch, bypassing the voltage conversion unit.

At S1307: the at least two batteries may be connected in the aforementioned balanced connection mode until the voltage difference falls within the preset voltage threshold range, and then the connection may be switched back to the first connection mode.

S1307 may be consistent with the corresponding step in the previous embodiments and will not be repeated in this embodiment.

The present embodiment provides a battery balance control method where the operating states of the at least two batteries are the discharging state. The method may include: based on the first connection mode being series, if the system load meets the high load condition and the voltage difference does not fall within the preset voltage threshold range, controlling the current limiting units connected in parallel with the at least two batteries to discharge as a discharge structure to achieve discharge balance; based on the first connection mode being series, if the system load meets the high load condition and the voltage difference does not fall within the preset voltage threshold range, controlling the at least two batteries to switch to a parallel connection. In this embodiment, based on the operating states of the at least two batteries being the discharge state, and considering the voltage difference and the first connection mode, when the system load is high, the system load may be maintained; when the system load is not high, the battery voltage difference may be reduced. The above objectives may be achieved by controlling the switching to different balanced connection modes.

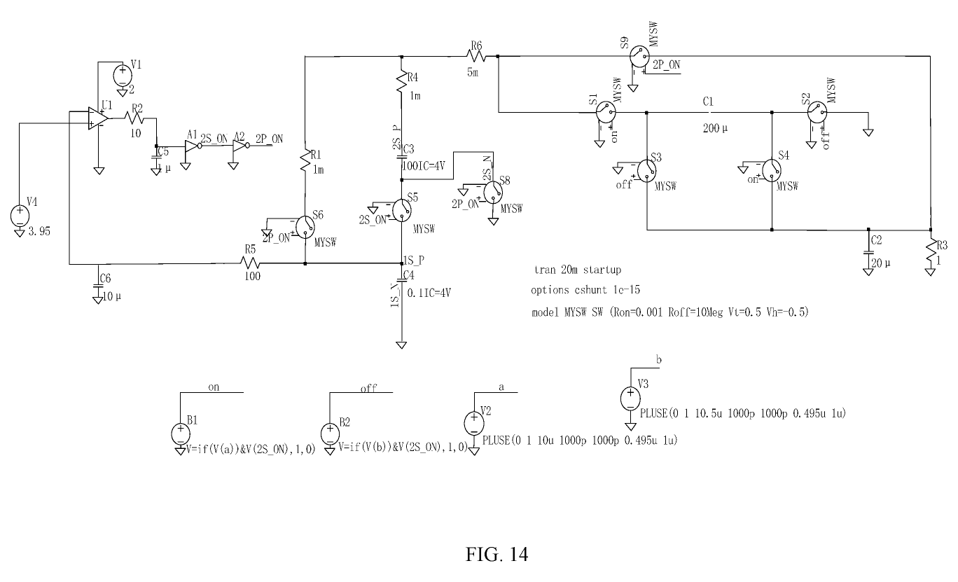

FIG. 14 shows a circuit topology simulation diagram of an electronic device provided by the present disclosure. In FIG. 14, a 100F (farad) capacitor C3 and a 1F capacitor C4 represent two batteries, 1 and 2, both with an initial voltage of 4V. The switching frequency of the voltage conversion unit Div2 is set to 1MHz, and the output voltage is half the input voltage. A resistor R3 represents the system load, with a resistance of 1 Ohm. The initial output voltage of Div2 is 4V, and the system load current is 4A.

In this simulation scenario, the voltage threshold is 3.95V. The voltage of VBAT_S1 is compared with 3.95V. When VBAT_S1 is detected to be lower than 3.95V, the system switches to parallel mode; or when it is higher than 3.95V, it switches back to series mode.

It should be noted that this simulation does not consider system strategy control (i.e., it does not consider the system charging/discharging state or load requirements), but only verifies the battery topology switching and simulates the control scheme.

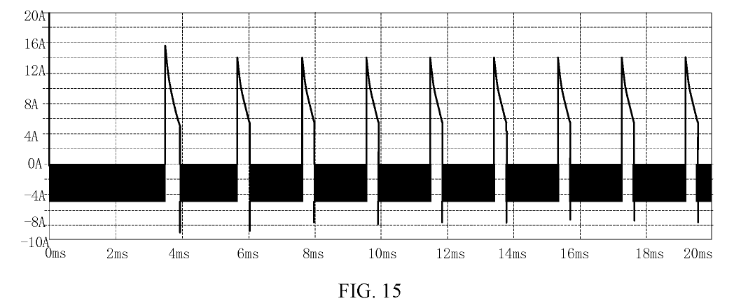

FIG. 15 shows the current curve of C4 in the circuit topology simulation results of an electronic device provided by the present disclosure. C4 represents the battery 1, and the curve represents the continuous charging and discharging of the battery 1.

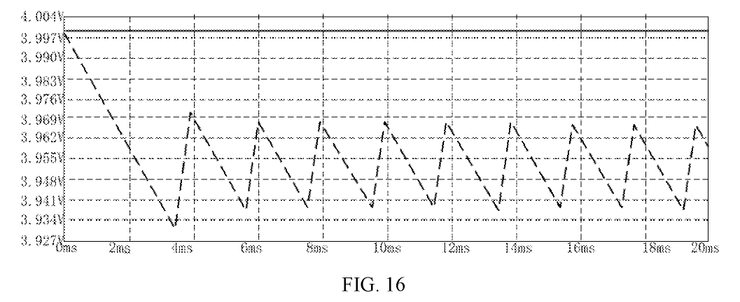

FIG. 16 shows the voltage curves of the two batteries in the circuit topology simulation results of an electronic device provided by the present disclosure. The solid line represents V(2s_p) - V(2s_n), representing the voltage of the battery 2. The dashed line represents V(1s_p), representing the voltage of the battery 1. The curves in this figure indicate that the battery 2 is continuously discharging, while the battery 1 is continuously charging and discharging.

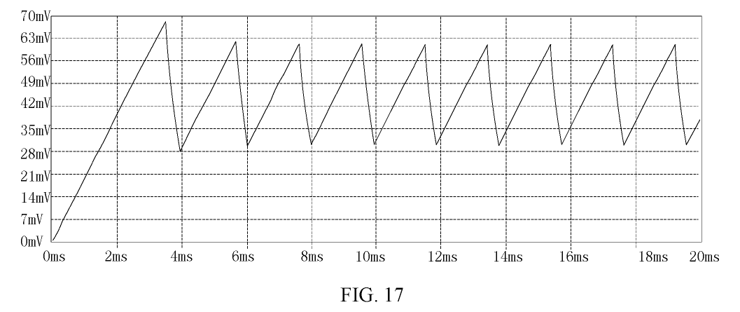

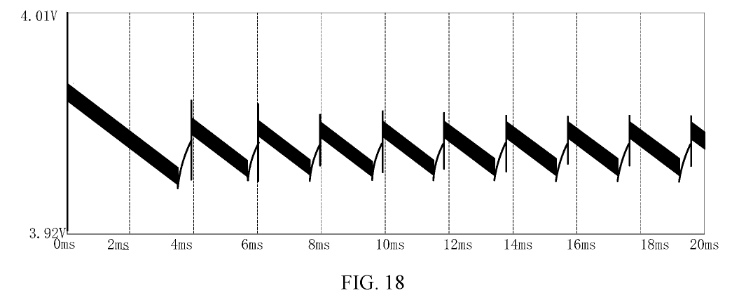

FIG. 17 shows the voltage difference curve of the two batteries in the circuit topology simulation results of an electronic device provided by the present disclosure. The curves in the FIG. 17 indicate that the voltage difference between the two batteries remains within a certain range.

FIG. 18 shows the system voltage curve in the circuit topology simulation results of an electronic device provided by the present disclosure. The system voltage fluctuation is within 40mV.

Based on the simulation results shown in FIG. 15 to FIG. 18, it can be seen that by using the electronic device and the battery balance control method applied to the electronic device provided by the present disclosure, the system voltage may be kept stable and the voltage difference may be kept within a certain range, thus achieving battery balancing for the electronic device.

Corresponding to the battery balance control method provided by various embodiments of the present disclosure, the present disclosure also provides an electronic device and a readable storage medium corresponding to the battery balance control method. The electronic device may include a memory and a processor.

The memory may be configured to store a processing program. The processor may be configured to load and execute the processing program stored in the memory to implement the battery balance control method provided by various embodiments of the present disclosure. For the specific implementation of the battery balance control method by this electronic device, references may be made to the aforementioned battery balance control method embodiments.

The readable storage medium may be configured to store a computer program. The program may be called and executed by a processor to implement the steps of the battery balance control method provided by various embodiments of the present disclosure. For the specific implementation of the battery balance control method by this electronic device, references may be made to the aforementioned battery balance control method embodiments.

The various embodiments in this specification are described in a progressive manner, with each embodiment focusing on the differences from other embodiments. Similar or identical parts between embodiments can be referred to mutually. For the apparatus provided in the embodiments, since it corresponds to the method provided in the embodiments, the description is relatively simple and relevant parts can be referred to the method section.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An electronic device, comprising:
a battery assembly including at least two batteries and a switching component, wherein the switching component is configured to switch a connection mode between the at least two batteries; and
a controller, connected to the switching component and configured to control the switching component to connect the at least two batteries in a corresponding target connection mode based at least on operating states of the at least two batteries, wherein the operating states include at least one of a charging state or a discharging state and the target connection mode includes at least one of a parallel connection or a series connection.

2. The device according to claim 1, wherein:
the controller includes a detection unit and a control unit, wherein the detection unit is configured to detect voltage difference between the at least two batteries and the control unit is configured to determine the target connection mode based on the operating states and the voltage difference.

3. The device according to claim 2, wherein:
the battery assembly includes a first battery and at least one second battery;
the switching component includes a plurality of switches;
a negative terminal of the first battery is grounded, and the negative terminal and a positive terminal of the first battery are connected in parallel through a first switch;
the at least one second battery is connected in series through at least one second switch, wherein the at least one second switch forms a second switch series and the at least one second battery forms a second battery series;
a negative terminal of each second battery is grounded through a corresponding third switch;
a negative terminal of the second switch series is connected to the positive terminal of the first battery through a fourth switch;
a fifth switch is connected between a positive terminal and a negative terminal of each second battery;
a positive terminal of the second battery series is connected to a voltage output terminal; and
the negative terminal of the second battery series is grounded through a third switch.

4. The device according to claim 3, wherein:
the detection unit includes:
a first comparator for comparing the voltage difference between the first battery and the at least one second battery; and
a second comparator for comparing the voltage difference with a preset voltage threshold range, and outputting a first signal to the circuit based on the voltage difference not falling within the preset voltage threshold range.

5. The device according to claim 4, wherein:
the control unit includes: an AND circuit with one input terminal connected to an output terminal of the second comparator and another input terminal connected to a system terminal signal, which is configured to generate a first control signal based on the first signal and the system terminal signal, wherein the first control signal is used to control a connection mode of the at least two batteries within the battery assembly, and the system terminal signal is used to characterize a system control strategy corresponding to the operating states.

6. The device according to claim 3, wherein:
the battery assembly further includes:
a first current limiting unit connected in parallel between the positive and negative terminals of the first battery, wherein the first current limiting unit is connected in series with the first switch; and
at least one second current limiting unit, wherein one second current limiting unit is connected in parallel between the positive and negative terminals of a corresponding one of the at least one second battery, and the at least one second current limiting unit is connected in series with the fifth switch.

7. The device according to claim 1, further comprising:
a voltage conversion module including a voltage conversion unit and a sixth switch, wherein:
the sixth switch is connected in parallel between an input terminal and an output terminal of the voltage conversion unit;
the sixth switch is open when the at least two batteries are connected in series and closed when the at least two batteries are connected in parallel; and
the voltage conversion unit is used to: convert a supply voltage output by the at least two batteries connected in series in the discharging state to a system load into a voltage that meets a power supply condition of the system load, and to convert a charging voltage received by the at least two batteries connected in series in the charging state into a voltage required for charging.

8. A battery balance control method of an electronic device with at least two batteries, comprising:
determining operating states of the at least two batteries, wherein the operating states include a charging state or a discharging state; and
controlling the at least two batteries to be connected in a corresponding target connection mode at least based on the operating states of the at least two batteries, wherein the target connection mode includes a parallel connection or a series connection.

9. The method according to claim 8, wherein controlling the at least two batteries to be connected in the corresponding target connection mode at least based on the operating states of the at least two batteries includes:
detecting voltage difference between the at least two batteries; and
controlling the at least two batteries to be connected in the corresponding target connection mode based on the operating states and the voltage difference of the at least two batteries.

10. The method according to claim 9, wherein controlling the at least two batteries to be connected in the corresponding target connection mode based on the operating states of the at least two batteries and the voltage difference includes:
based on a preset system strategy, selecting a first connection mode corresponding to the operating states of the at least two batteries; and
when the voltage difference is within a preset voltage threshold range, controlling the at least two batteries to be connected using the first connection mode.

11. The method according to claim 10, further comprising:
when the voltage difference is not within the preset voltage threshold range, determining that the connection mode is switched from the first connection mode to a balanced connection mode, and controlling the at least two batteries to be connected using the balanced connection mode until the voltage difference falls within the preset voltage threshold range, at which point the connection mode is switched back to the first connection mode, wherein the balanced connection mode is used to reduce the voltage difference.

12. The method according to claim 11, wherein, when the operating states of the at least two batteries are the charging state, determining that the connection mode is switched from the first connection mode to the balanced connection mode includes:
based on the at least two batteries being in a first stage of the charging state, when the first connection mode is the parallel connection and the voltage difference is not within the preset voltage threshold range, controlling current-limiting units connected in parallel with the at least two batteries to shunt a charging current, wherein the charging current of the at least two batteries in the first stage is less than a preset current threshold; and
based on the at least two batteries being in the first stage of the charging state, when the first connection mode is the series connection and the voltage difference is not within the preset voltage threshold range, controlling the at least two batteries to switch to the parallel connection to balance the charging current of the at least two batteries.

13. The method according to claim 12, further comprising:
based on the at least two batteries being in a second stage of the charging state, when the first connection mode is the series connection and the voltage difference is not within the preset voltage threshold range, controlling the current-limiting units connected in parallel with the at least two batteries to shunt the charging current, or controlling the at least two batteries to switch to the parallel connection to balance the charging current of the at least two batteries, wherein the charging current of the at least two batteries in the second stage is larger than the preset current threshold; and
based on the at least two batteries being in a third stage of the charging state, when the first connection mode is the parallel connection and the voltage difference is not within the preset voltage threshold range, controlling the current-limiting units connected in parallel with the at least two batteries to shunt the charging current, wherein the charging current of the at least two batteries in the third stage is fixed.

14. The method according to claim 11, wherein, when the operating states of the at least two batteries are the discharging state, determining that the connection mode is switched from the first connection mode to the balanced connection mode includes:
based on the first connection mode being the series connection, when the system load meets a high load condition and the voltage difference is not within the preset voltage threshold range, controlling current-limiting units connected in parallel with the at least two batteries to discharge as a discharge structure to achieve discharge balance; and
based on the first connection mode being the series connection, when the system load does not meet the high load condition and the voltage difference is not within the preset voltage threshold range, controlling the at least two batteries to switch to the parallel connection.

15. A non-transitory computer-readable storage medium containing computer program that, when being executed, causes one or more processors to implement a battery balance control method of an electronic device with at least two batteries to perform:
determining operating states of the at least two batteries, wherein the operating states include a charging state or a discharging state; and
controlling the at least two batteries to be connected in a corresponding target connection mode at least based on the operating states of the at least two batteries, wherein the target connection mode includes a parallel connection or a series connection.

16. The storage medium according to claim 15, wherein the one or more processors are further configured to perform:
detecting voltage difference between the at least two batteries; and
controlling the at least two batteries to be connected in the corresponding target connection mode based on the operating states and the voltage difference of the at least two batteries.

17. The storage medium according to claim 16, wherein the one or more processors are further configured to perform:
based on a preset system strategy, selecting a first connection mode corresponding to the operating states of the at least two batteries; and
when the voltage difference is within a preset voltage threshold range, controlling the at least two batteries to be connected using the first connection mode.

18. The storage medium according to claim 17, wherein the one or more processors are further configured to perform:
when the voltage difference is not within the preset voltage threshold range, determining that the connection mode is switched from the first connection mode to a balanced connection mode, and controlling the at least two batteries to be connected using the balanced connection mode until the voltage difference falls within the preset voltage threshold range, at which point the connection mode is switched back to the first connection mode, wherein the balanced connection mode is used to reduce the voltage difference.

19. The storage medium according to claim 18, wherein the one or more processors are further configured to perform:
based on the at least two batteries being in a first stage of the charging state, when the first connection mode is the parallel connection and the voltage difference is not within the preset voltage threshold range, controlling current-limiting units connected in parallel with the at least two batteries to shunt a charging current, wherein the charging current of the at least two batteries in the first stage is less than a preset current threshold; and
based on the at least two batteries being in the first stage of the charging state, when the first connection mode is the series connection and the voltage difference is not within the preset voltage threshold range, controlling the at least two batteries to switch to the parallel connection to balance the charging current of the at least two batteries.

20. The storage medium according to claim 19, wherein the one or more processors are further configured to perform:
based on the at least two batteries being in a second stage of the charging state, when the first connection mode is the series connection and the voltage difference is not within the preset voltage threshold range, controlling the current-limiting units connected in parallel with the at least two batteries to shunt the charging current, or controlling the at least two batteries to switch to the parallel connection to balance the charging current of the at least two batteries, wherein the charging current of the at least two batteries in the second stage is larger than the preset current threshold; and
based on the at least two batteries being in a third stage of the charging state, when the first connection mode is the parallel connection and the voltage difference is not within the preset voltage threshold range, controlling the current-limiting units connected in parallel with the at least two batteries to shunt the charging current, wherein the charging current of the at least two batteries in the third stage is fixed.
